(19) United States
(12) Patent Application Publication
(10) Pub. No.: US 2014/0110010 A1
(43) Pub. Date: Apr. 24, 2014

(54) CONNECTION ARRANGEMENT

(71) Applicant: Detlev Ulle, Ostheim (DE)

(72) Inventor: Detlev Ulle, Ostheim (DE)

(73) Assignee: DE-STA-CO EUROPE GMBH, Oberursel (DE)

(21) Appl. No.: 13/806,362

(22) PCT Filed: Jun. 19, 2012
(86) PCT No.: PCT/DE2012/100181

§ 371 Date: Apr. 16, 2013

(30) Foreign Application Priority Data
Jun. 23, 2011 (DE) 102011105715.7

(51) Int. Cl. F16L 47/06

(52) U.S. Cl. CPC F16L 47/06
USPC 138/109

(57) ABSTRACT

A connection arrangement comprising a tube element formed from a fiber composite material, the tube element has a conically shaped tube attachment area on one of its ends; a flange attachment area is provided on a flange element, the flange attachment area is inversely conically shaped to the tube element; the tube element and the conically shaped tube attachment area are integrally formed and the tube attachment area is glued to the flange attachment area.

### CROSS-REFERENCE TO RELATED APPLICATIONS

This application is a 371 U.S. National Stage of International Application No. PCT/DE2012/100181, filed Jun. 19, 2012. This application claims priority to German Patent Application No. 102011105715.7, filed Jun. 23, 2011. The disclosures of the above applications are incorporated herein by reference.

The disclosure relates to a connection arrangement and, more particularly, to a connection arrangement with a tube element formed from a fiber composite material, the tube element has a conically shaped tube attachment area on one of its ends. A flange attachment area is provided on a flange element. The flange attachment area is inversely conically shaped to the tube element. The tube element and the conically shaped tube attachment area are integrally formed. The tube attachment area is glued to the flange attachment area.

A connection arrangement is known from EP 0 139 176 A1. It includes a tube element made from a fiber composite material. The tube element has a conically shaped tube attachment area on one of its ends. The conically shaped tube attachment area is implemented to match with a flange attachment area provided on a flange element and is inversely conically shaped. In this solution, the tube attachment area is slid, as a sleeve, on the outside onto the tube. It is glued to the tube. On its inside the flange element has the flange attachment area. Thus, the tube element, with the tube attachment area, can be inserted into the flange element with its flange attachment area. For mutual fixing, the flange element has a thread on its outside. The thread is designed to interact with a retaining ring that is supported by the sleeve-like tube attachment area.

As shown in EP 0 139 176 A1, the stipulation of “conically shaped” in abstract terms, refers to a cylindrical piece whose wall thickness varies in the direction of the principal axis of the cylinder. Thus, in particular, the wall thickness varies in a uniform manner. Depending on whether, in this arrangement (as is the case in EP 0 139 176 A1), the inside of the flange attachment area or the outside of the tube attachment area or vice versa (in other words different from the manner shown in EP 0 139 176 A1) the outside of the flange attachment area or the inside of the tube attachment area are conically shaped, optionally the flange attachment area or the tube attachment area encloses an imaginary truncated cone. The described solution according to EP 0 139 176 A1 is cost-intensive in terms of technical implementation.

Thus, it is an object of the disclosure to improve the above mentioned connection arrangement type, namely, in particular, in terms of the technical expenditure required.

This object is achieved by a connecting arrangement with a tube element formed from a fiber composite material. The tube element has a conically shaped tube attachment area on one of its ends. A flange attachment area is provided on a flange element. The flange attachment area is inversely conically shaped to the tube element. The tube element and the conically shaped tube attachment area are integrally formed. The tube attachment area is glued to the flange attachment area.

Thus, the disclosure provides an integral tube element and conically shaped tube attachment area. The tube attachment area is glued to the flange attachment area. In other words, according to the disclosure, and based on EP 0 139 176 A1, the disclosure does away with both the additional sleeve and the retaining ring.

Taking into account the connection arrangement according to the invention it is, in particular, used as part of a supporting frame. For example, it is used in robots for the attachment of tools such as clamping devices and the like. There are no disadvantages if the above-mentioned components are glued together. However, apart from the reduction in the number of components used, there is a significant advantage in the overall construction in that it is considerably lighter in weight.

This is the case all the more so if, as provided, the tube element is made from a fiber composite material. For example, a carbon fiber composite or a glass fiber composite may be used. This material provides good stability and at the same time is very lightweight by nature. Thus, the fiber composite material is particularly well-suited for the manufacturing of a supporting frame. This is known from, for example, EP 1 607 638 B1 or from the post-published DE 10 2011 101 454 A1. In this arrangement the flange element with its flange attachment area, which can, of course, also be provided on both ends of the tube element, preferably includes a metallic material, particularly preferably, die-cast aluminium.

For the sake of completeness, reference is also made to the solution according to DE 1 162 651 B. It is however not a tube element including a fiber composite material. It is an interior lining of a metal tube with the interior lining formed from rubber. It includes a conically shaped tube attachment area.

Further areas of applicability will become apparent from the description. The description and specific examples in this summary are intended for purposes of illustration only and are not intended to limit the scope of the present disclosure.

The connection arrangement according to the disclosure, including its advantageous improvements, is explained in more detail below with reference to the drawings of two exemplary embodiments.

### BRIEF DESCRIPTION OF THE DRAWINGS

FIG. 1 is a cross-section view of a first embodiment of the connection arrangement with a tube element and two flange elements;

FIG. 2 is a lateral elevation view of the flange element according to the disclosure of FIG. 1;

FIG. 3 is a perspective view of the flange element according to FIG. 2; and

FIG. 4 is a cross-section view of a second embodiment of a connection arrangement.

### DETAIL—DESCRIPTION

The connection arrangement shown in the figures, that is used to form a supporting frame for robots, includes a tube element 1 made from a fiber composite material. The tube element 1 has a conically shaped tube attachment area 2 on one of its ends. The conically shaped tube attachment area 2 is implemented to match a flange attachment area 4 that is provided on a flange element 3. The flange attachment area 4 is inversely conically shaped.

The flange element 3 may be formed from a metallic material. Particularly, in this arrangement, aluminum is desirable and, in particular, die-cast aluminum is provided. As an alternative, synthetic materials can also be considered.

It is significant in the connection arrangement, according to the disclosure that the tube element 1 and the conically shaped tube attachment area 2 are integral. The tube attachment area 2 is implemented so as to be glued to the flange attachment area 4.

In the above-mentioned field of application in the case of supporting frames and associated endeavour it is desirable to design the aforesaid so that they are as lightweight as possible. Furthermore, it is preferable that the tube element 1 have a wall thickness that is several times smaller than the diameter of the tube element 1.

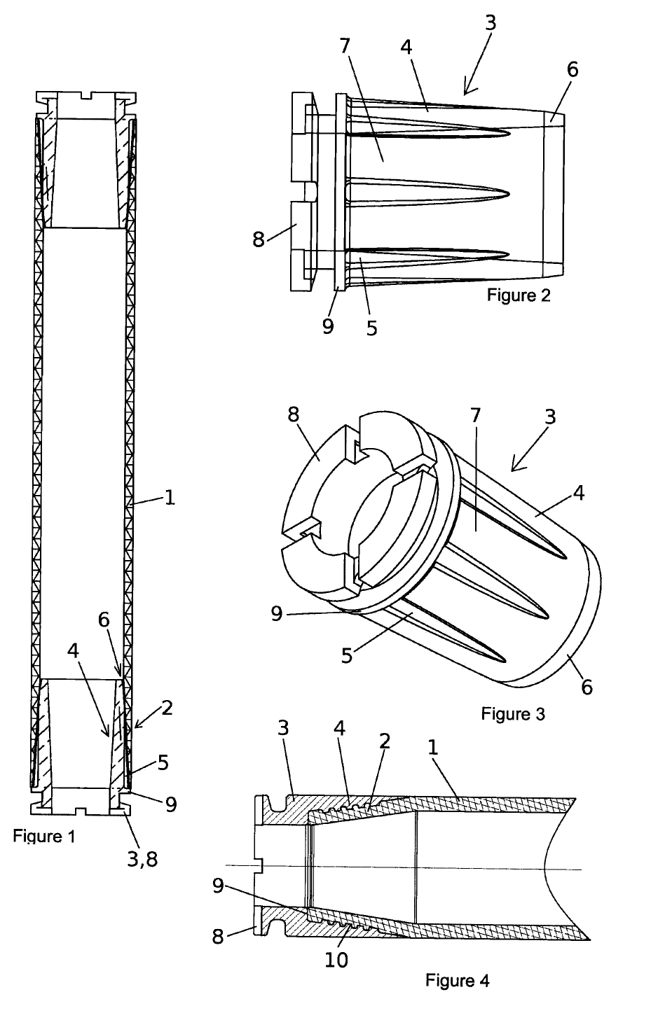

In contrast to the above-mentioned state of the art, with reference to FIGS. 1 to 3, preferably the tube attachment area 2 is arranged on the inside of the tube element 1. The flange attachment area 4 is arranged on the outside of the flange element 3. In other words, in the solution according to FIGS. 1 to 3, the flange element 3 is inserted into the tube element 1. During this process the two are glued together.

As an alternative, according to FIG. 4, the tube attachment area 2 is arranged on the outside of the tube element 1. The flange attachment area 4 is arranged on the inside of the flange element 3. In other words, in the solution according to FIG. 4, the tube element 1 is inserted into the flange element 3 and glued together.

As illustrated in FIGS. 1 to 3 the tube element 1 includes a base wall thickness that becomes thinner towards the end of the tube element 1. Thus, this creates the conically formed tube attachment area 2. Accordingly, the wall thickness becomes continuously thinner.

As an alternative, according to FIG. 4, the tube attachment area 2 is conically shaped on both the outside and on the inside of the tube element 1. The tube element 1 is designed with an overall conical taper at its free end.

Furthermore, in the embodiments shown, the flange element 3 is tubular in shape. The flange attachment area 4 of the tubular flange element 3 includes a base wall thickness. Thus, in order to form the conical shaped flange attachment area 4 it is designed to become thinner towards the end of the flange element 3. Preferably, the wall thickness becomes continuously thinner.

At least one groove 5 is provided to ensure particularly good anti-rotation. This occurs by a positive-locking arrangement to supplement the integral fit provided by adhesion between the tube element 1 and the flange element 3. The flange attachment area 4 includes the at least one groove 5. The groove 5 has an overall triangular shape that extends parallel to the principal axis of the tube element 1. The apex of the triangle extends inward into the tube 1. The base of the triangle extends on to the counter bearing 9. The flange element according to FIGS. 1 to 3 includes eight such grooves.

An edge region 6 is provided to reduce the danger of the connection arrangement kinking under load at the region of the end of the flange element 3. The end is situated in the tube element 1. The flange element 3 on its end on the side of the tube element includes the edge region 6. The edge region 6 further tapers off so that it does not contact the tube element 1.

A roughened surface 7 is provided on the flange attachment area 4 to further improve the adhesive connection between the tube element 1 and the flange element 3. The flange attachment area 4 includes the roughened surface 7 on the side of the tube attachment area. Thus, the actual overall adhesive surface is larger than in the case of a smooth surface.

As an alternative, in the embodiment according to FIG. 4, both the tube attachment area 2 of the tube element 1, and the tube attachment area 4 of the flange element 3 include undercuts 10. The undercuts 10 match each other in a positive-locking manner. The undercuts 10 are in the form of channels and indentations. The undercuts 10 extend radially to the principal axis of the tube element 1.

In this solution slits 11 are provided to enable sliding of the flange element 3 onto the tube element 1 during installation or gluing. Thus, the tube attachment area 2 of the tube element 1 and/or the tube attachment area 4 of the flange element 3 include the slits.

In order to be able to use the connection arrangement in particular as a supporting frame, a coupling element 8 is provided on one end of the flange element 3 of the flange attachment area 4. A counter bearing 9 for the tube element 1 is arranged between the flange attachment area 4 and the coupling element 8. The tube element 1 comes to rest during slide-on (FIGS. 1 to 3) or during insertion (FIG. 4) on the counter bearing 9 in the flange element 3.

Finally, for reasons relating to weight and stability, as already explained in the introduction, it is provided that the tube element 1 is made from a fiber composite material. The material is well suited to taking up tensile forces and compressive forces as well as torsional moments.

The description of the disclosure is merely exemplary in nature and thus, variations that do not depart from the gist of the disclosure are intended to be within the scope of the disclosure. Such variations are not to be regarded as a departure from the spirit and scope of the disclosure.

1-12. (canceled)

13. A connection arrangement, comprising:
a tube element formed from a fiber composite material, the tube element has a conically shaped tube attachment area on one of its ends;
a flange attachment area is provided on a flange element, the flange attachment area is inversely conically shaped to the tube element;
the tube element and the conically shaped tube attachment area are integrally formed and the tube attachment area is glued to the flange attachment area.

14. The connection arrangement according to claim 13,
wherein the tube attachment area is optionally arranged on an inside surface or on an outside surface of the tube element.

15. The connection arrangement according to claim 13,
wherein the tube element includes a base wall thickness that creates the conically formed tube attachment area, the base wall thickness becomes thinner towards the end of the tube element the base wall thickness becomes continuously thinner.

16. The connection arrangement according to claim 13,
wherein the flange attachment area is optionally arranged on an outside surface or on an inside surface of the flange element.

17. The connection arrangement according to claim 13,
wherein the flange element is tubular in shape, and the flange attachment area of the tubular flange element includes a base wall thickness that becomes thinner towards the end of the flange element to form the conically shaped flange attachment area, the base wall thickness becomes continuously thinner.

18. The connection arrangement according to claim 13,
wherein the flange attachment area includes at least one groove extending from an end of the flange parallel to the principal axis of the tube element.

19. The connection arrangement according to claim 13,
wherein the flange element on its end on a side of the tube element includes an edge region that tapers off and does not contact the tube element.

20. The connection arrangement according to claim 13,
wherein the flange attachment area on the side of the tube attachment area includes a roughened surface.

21. The connection arrangement according to claim 13,
wherein a coupling element is provided on one end of the flange element of the flange attachment area and on the other end of the flange element.

22. The connection arrangement according to claim 13,
wherein the tube attachment area is conical in shape both on an outside surface and on an inside surface of the tube element.

23. The connection arrangement according to claim 13,
wherein both the tube attachment area of the tube element and the tube attachment area of the flange element comprise undercuts that match each other in a positive-locking manner.

24. The connection arrangement according to claim 23,
wherein the tube attachment area of the tube element and/or the tube attachment area of the flange element include slits parallel to the principal axis of the tube element.
